(19) United States
(12) Patent Application Publication
(10) Pub. No.: US 2016/0002120 A1
(43) Pub. Date: Jan. 7, 2016

(54) Hydro-mulch and organic fertilizer composition and process

(71) Applicants: Robert Parker, Milton, KY (US); James A. Grider, Louisville, KY (US); James Nichols, Louisville, KY (US); Kevin Riggle, Louisville, KY (US)

(72) Inventors: Robert Parker, Milton, KY (US); James A. Grider, Louisville, KY (US); James Nichols, Louisville, KY (US); Kevin Riggle, Louisville, KY (US)

(21) Appl. No.: 14/545,300

(22) Filed: Apr. 20, 2015

Related U.S. Application Data
(60) Provisional application No. 61/995,738, filed on Apr. 18, 2014.

(51) Int. Cl. C05G 3/04; C09K 17/52; C05G 3/00; C05F 3/00

(52) U.S. Cl. CPC C05G 3/04; C05F 3/00; C09K 17/52; C05G 3/0076

(57) ABSTRACT

A combination of mulch and sterilized organic fertilizer is provided for hydro seeding and hydro-mulching for seed establishment and erosion control. The composition includes hammer milled straw, horse manure and urine, sterilized with heat and processed to provide an optimal particle size. The incorporation of horse manure utilizes a dispersible natural fertilizer collected and processed within a certain time frame which provides an efficient method of recycling “green” horse manure” and liquid waste having a higher acidity than decomposed animal waste. Tackifiers and flocculants such as ground paper aid pumpability and help tack the straw fibers to the ground. The equipment includes a gas heat source, a dryer vessel and a processing unit. The dryer vessel receives the bedding composed of straw and manure for contact with the heated gases to convert the same to a sterilized dry material.

### CROSS REFERENCES TO RELATED APPLICATIONS

This application claims priority from U.S. Provisional Application Ser. No. 61/995,738 filed on Apr. 18, 2014 and is incorporated by reference in its entirety.

### FIELD OF THE INVENTION

The present invention relates to the field of erosion control and seed establishment with hydro seeding and hydromulching.

### BACKGROUND OF THE INVENTION

The intensive use of agricultural and horticultural areas requires fertilisers to be added for optimal production of grasses or crops. Mineral fertilisers added can compensate for the used up nutrients; however, the product is expensive and is applied in powder or more typically applied in pellet form by drill, broadcase, or liquid application means directly to the field where at least a portion is susceptible to dissolving in rain and running into ponds, streams, rivers, lakes and other areas of the drainage ecosystem resulting in undesirable algae bloom and contamination. Fertilizing exclusively on the basis of mineral fertilisers has, however, the disadvantage that no organic substance is supplied to the intensively used soil. Organic substance in the soil is important for the preservation of fertility. For this reason humus-forming organic substance is added time and again at regular intervals as a soil improving measure. Animal manure has proved to be especially suitable. However, handling animal manure requires a great deal of work and the stench can cause nuisance, particularly in allotments.

Existing systems for erosion control and seed establishment use paper, wood such as sawdust, paper/straw/jute combinations to provide a hydro mulch composition. These hydro mulches are difficult to use and have low performance efficiencies. Additionally, application of paper and wood hydro mulches is limited by the amount of water that can be carried on a hydro mulch spreader. Generally, paper and wood hydro mulches require large quantities of water for efficient spreading. Use of straw mulches has not been successful in hydro seeding. All of these compositions typically require liquid or fertilizer to be applied simultaneously with or added to the mulch to enhance the growth of grass in the mulched areas. Moreover, the clogging of the pumps and nozzles during hydro seeding and hydromulching is a problem that needs to be addressed by control of the particle size.

Conventional methods of applying paper or wood hydro mulches spread seed and mulch by using truck mounted pumps and water cannons for large area applications. The composition of the present invention is dried and sterilized and may be bagged and sold in garden centers and the like with little or no objectionable odor so long as the product is packaged in a moisture proof or resistant container, box, or bag. The product is useful in hot houses, flower gardens, and homes in addition to road side commercial application for control of drainage and erosion.

There is an emphasis in developed countries on the production of food crops by use of certified organic crop production processes and materials. The United States and other countries have developed standards for qualifying food products as “organic” or “organically produced,” and several certifying organizations and government agencies exist to certify farms and market produce as “organic” under the appropriate standards. The concept underpinning “organic” food and crop production is that the inputs used in crop or animal production (fertilizer, seeds, feeds, sprays, etc.) are allowed to contain only minimal levels of certain approved non-natural materials, such as synthetic chemical fertilizers, genetically modified organisms. The food products are not allowed to contain any amount of designated undesirable materials, such as pesticides, drugs, growth hormones, pathogens.

There is rapidly increasing consumer demand for organic products. The “certified organic” labeling and terminology has been developed to define products or produce certified by recognized organizations as meeting the applicable agency standards and product or produce made by methods that meet the agency standards for organic production methods. An essential aspect of certified organic food production is the necessity of using production means that are certified organic, such as fertilizers, which are either approved, such as materials containing no pathogens or other disqualifying components, or regulated and accepted, such as manures, composts and the like that meet the applicable standards.

There is a substantial need for environmentally and economically acceptable technologies for disposal of manure, for control of noxious and greenhouse gases from animal feeding operations, and for production of organic fertilizer and soil builder products that can be certified for food production under established standards for certified organic food production. The present invention is directed to methods, apparatus, systems and products for these needs.

The natural fertilizers according to the present invention consists of formed and broken horse droppings material and contains among other things essential trace elements, the concentration of which in the soil has fallen off in the soil and particularly on areas intensively used. It contains important primary nutrients, as nitrogen and phosphorus, besides such important micro-nutrients like selenium and iodine.

### DESCRIPTION OF THE RELATED ART

Examples of the prior art and publications that have addressed the production of organic or certified organic fertilizer products are U.S. Pat. No. 5,354,349 to Inoue; U.S. Pat. No. 6,461,399 to Connell; U.S. Pat. Nos. 6,517,600 and 6,645,267 to Dinel; U.S. Patent Applications 2003/0038078 by Stamper et al., 2003/0089151 and 2003/0136165 by Logan et al., and 2003/0111410 by Branson.

### SUMMARY

A combination of mulch and sterilized organic fertilizer in the form of horse muck is provided for hydro seeding and hydromulching for seed establishment and erosion control. The composition includes hammer milled straw, horse manure and urine, sterilized with heat and processed to provide an optimal particle size. The incorporation of horse manure utilizes a dispersible natural fertilizer characterized in that the horse droppings excreted by horses are collected and processed within a certain time frame which covers preservation of a natural humidity and loose structure of the horse droppings as much as possible and provides an efficient method of recycling “green” horse manure” and liquid waste having a higher acidity than decomposed animal waste. The hammer milled straw is used for its water holding capacity, pumpability, and reduction in the amount of water required for pumping a quantity of mulch. The mulch and fertilizer composition of the present invention may include other additives as well. Tackifiers and flocculants aid pumpability and help tack the straw fibers to the ground and aid in water infiltration and water clarity. A surfactant may be added to enhance wettability. Other additives such as dyes may be used to enhance the appearance of the product. This invention discloses a process for conversion of manure and animal waste to fertilizer and/or soil builder products useful as an ingredient for organic farming operations. The equipment systems includes a gas turbine generator unit as a heat source, a dryer vessel and a processing unit, wherein the connection between the gas turbine and the dryer vessel directs substantially all the gas turbine exhaust into the dryer vessel. The dryer vessel receives the bedding composed of straw and manure for contact with the turbine exhaust gases to convert the same to a sterilized dry material.

The present composition comprises or consists essentially of a straw mixed with horse manure to prepare a mulch for hydro seeding and hydromulching for seed establishment and erosion control. The product is mixed with water and sprayed over bare ground with seed and fertilizer in a slurry to establish ground cover which provides shade to seedlings and retain moisture. The process utilizes a tower dryer having a series of shelves to dry the mulch materials at from 200-350° F. for 3-5 minutes to control humidity. The mixture is moved through the system using a cyclone which enables conveyance of the product without subject the product to blades providing a means for controlling the size of the product throughout the drying and sizing process. Thus is able to utilize horse muck which is used bedding having a high moisture content as a fertilizer in their hydro mulch product which adds nutrients and provides a means to reduce the amount of chemical fertilizer used in the mixture.

The present method utilizes horse manure which is processed together with straw and, if necessary, further additions of synthetic or natural fertilisers. In particular, damp horse manure is used as initial material to which straw or other supplements and other animal dung is added. The advantage of this natural fertilizers made of horse manure is that particularly the addition of straw retards decomposition of the natural fertilizers.

It is an object of the present invention to tumble the feed material including straw and horse muck at extreme heat just at flash point with temperatures between 250 F and 450 F depending on incoming moisture.

It is an object of the present invention to pneumatically convey material drying in hot air stream at speeds between 3500 FPS and 4500 FPS for appropriate breakdown of materials lignins and decontamination of soiled material.

It is an object of the present invention to provide for milling and sizing of the feed material and process same to a dimension no greater than ½″ in length and vertical fracturing of material for optimum performance through a hydro seeding machine and perfect blending of complementary ingredients for superior performance on the ground to achieve vegetation and erosion control.

It is an object of the present invention to sterilize any weed seeds present in the mulch and fertilizer composition during the drying process.

It is an object of the present invention to produce a composition which includes ordinary horse manure which consists of straw, urine straw and pieces of horse manure.

It is an object of the present invention to produce a composition which includes horse manure having between 5 and 25 percent moisture and more preferably between 10-20% moisture and most preferably about 10% moisture.

It is an object of the present invention to utilize an inert binder in the product.

It is an object of the present invention to provide a base product using only natural ingredients in the fertilizer.

It is an object of the present invention to provide a mulch including a natural fertilizer which is weed free.

It is an object of the present invention to utilize a wheat straw.

It is an object of the present invention to provide a mulch and fertilizer composition which is biodegradable.

It is an object of the present invention to provide a mulch and fertilizer composition which does not wash off and adheres to the ground.

It is an object of the present invention to provide a mulch and fertilizer composition which has an acidic composition suitable for the acidic soil applications such as for the wine industry or to lower the pH of alkaline soil.

It is an object of the present invention to product mulch particle sizes of ½ inch or smaller including fines is used to prepare a hydro mulch product.

It is an object of the present invention to product mulch particle sizes up to 10 inches in length for ground cover applications wherein the product is baled.

It is an object of the present invention provide a sterilized product and any seeds therein.

It is an object of the present invention to add hay straw to the product providing protein.

It is an object of the present invention to ship the product in bulk containers.

It is an object of the present invention to produce a product which can be used to produce Kosair food.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the views wherein:

FIG. 1 is a flow diagram showing the rock trap and hot box for the feed system;

FIG. 2 is a flow diagram of the processing system for treatment of the muck and straw feed material;

FIG. 3 is a flow diagram of the mixing process;

FIG. 4 is a flow diagram of the packaging process;

FIG. 5 shows the processing equipment including the cyclones, dryer boxes, hammer mill, and pull fan;

FIG. 6 is a perspective view showing the cyclones, vertical shelf heater, and hammer mill;

FIG. 7 is a perspective view showing the heater shelves or trays within the dryer box;

FIG. 8 is a perspective view showing the vertical shelf dryer box and conveyor system;

FIG. 9 is a perspective view showing shelf dryer boxes, the cyclones, conveying system, and feed system;

FIG. 10 is a schematic showing the process flow and equipment for one preferred embodiment of the present invention including the following components: 70 hotbox, 71 module feeder, 72 burner 1, 73 burner 2, 74 burner 3, 75 dryer 1, 76 dryer 2, 77 fan 1, 78 fan 2, 79 fan 3, 710 cyclone 1, 711 cyclone 2, 712 cyclone 3, 713 feed 1, 714 feed 2, 715 splitter transition, 716 hammer mill, 717cyclone re-bale, 718 surge bin long, 719 square baler, 720 bale bander, 721 power units, 722 conveyors, 723 screens, 724 cyclone for short straw, 725 surge bin for short straw, 726 unloader bin, 727 product bin 1, 728 product bin 2, 729 product bin 3, 730 finished product surge bin, 731 unloader for product surge, 732 air compressor, 733 reel mixer, 734 bully bagger feed, 735 bully bagger 1, 736 bully bagger 2, 737 palletizing frame, 738 pallet wrap, 739 conveyer, 740 conveyors, 741 dust and odor control, 742 moisture controls, 743 bale buster conveyor, 744 mobile equipment, 791 bin 1 compost, 792 bin 2 peat moss, 793 bin 3 wood, 794 bin 4 paper, 795 bin 5 cotton, 796 bin, and 797 bin; and

FIG. 11 is a schematic showing an alternate embodiment process flow diagram including the following major components: 310 module feeder, 311 conveyor, 312 heater, 314 hot air fan, 316 rotary air lock to control feed rate, 318 blower, 320 cyclone, 322 hammer mill, 324 hot air shelf dryer, 326 blower, 328 cyclone, 330 hammer mill, 332 hot air shelf dryer, 334 blower, 336 cyclone, and 338 bagger.

### DESCRIPTION OF THE PREFERRED EMBODIMENTS

### Process:

Wheat straw or other cereal grain straw, such as oat straw, is typically used for bedding material in the horse industry as well as for other domestic animals including cattle and sheep and for wild animals in zoos and animal habitats. The mixture of waste materials from the animals including manure and urine is collected after becoming saturated with waste and is delivered to the processing plant in walking floor trailers where it is stored in bulk for pneumatic conveyance into a feed system.

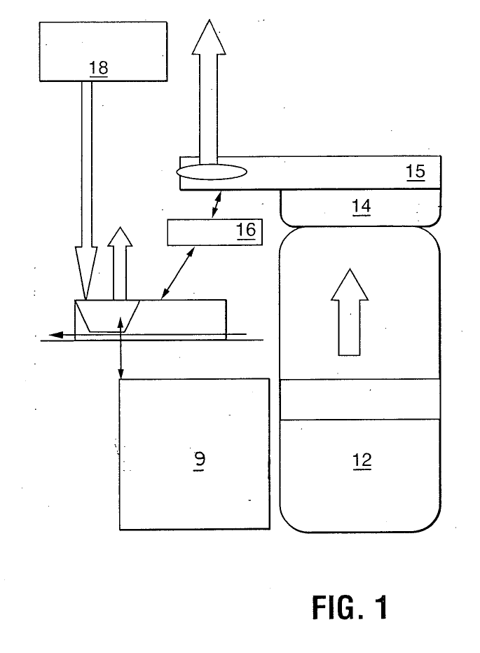

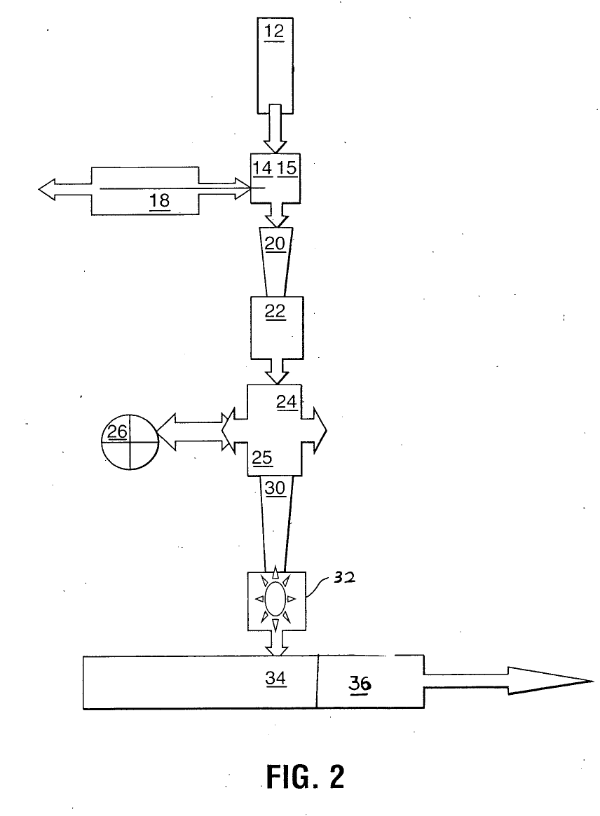

As shown in FIG. 1, the bulk feed is fed into the pneumatic conveying system via a live floor feed and break-up mechanism 12 wherein the muck feed is picked up into conveyance air stream and rocks, debris, and other heavy unwanted material is removed via a belt for disposal. Counter rotating spiked beaters 14 break up the much for delivery into the hot air stream and a high speed belt 15 moves the material to a hot box 16 where the feed system conveys the material through a vacuum line which enters a heated air stream. At about 3500 to 4500 feet per second material is delivered to the next stage where the feed material is subject to a 4 million BTU gas fired burner 18. The burner 18 heats the air up to 450° F. and the feed material as it is pneumatically conveyed into the air stream. The burner develops consistent heat of 250° F. to 450° F. for proper decontamination and sterilization of the microorganisms and seeds in the feed material. These temperature ranges also ensure proper break down of the lignins of the material.

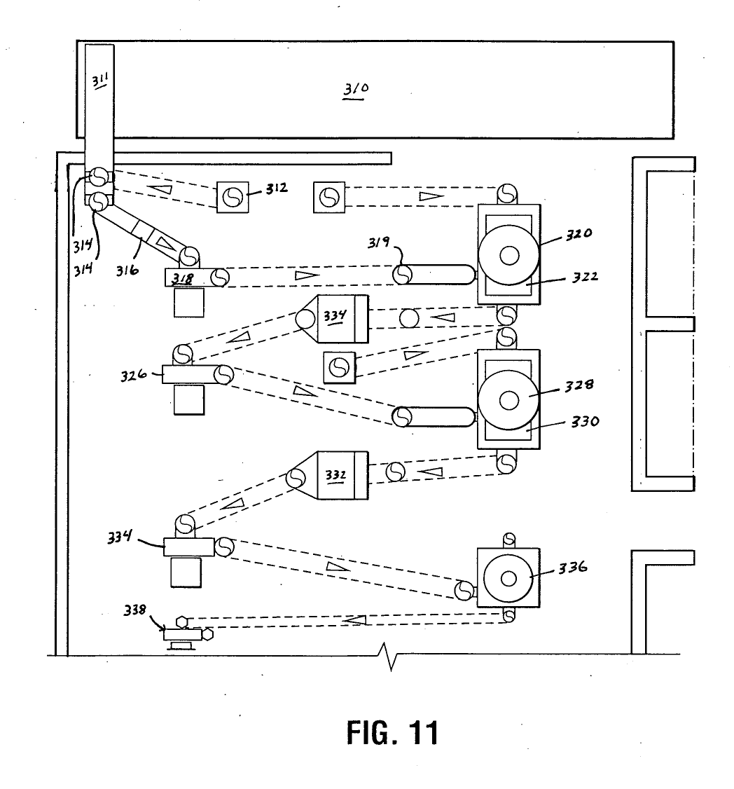

As best shown in the drawings in FIG. 11, a plurality of variable speed rotary air locks 319 are used throughout the blower and vacuum conveying system to control the rate of feed.

The material is then fed to a first cyclone 20 which allows moisture and spent air to escape while material collects into a feed control box 22 which collects material to be consistently fed back into the hot air stream for processing at a selected residence time through a dryer 24 or dryer box such as a shelf dryer, collider dryer, fountain dryer, or WALKER dryer. Selection of the dryer such as the WALKER dryer is considered an important and novel feature of the process, for the heated material is suspended in a hot air stream at 3500 to 4500 fps as it is conveyed to the dryer achieving a temperature in the dryer of 350 to 400° F. which heats the seeds to at least 200° F. for a selected period of time (usually 3-5 minutes per dryer), which kills any seeds to prevent germination and sterilized the organic product. Sufficient heat is supplied by the dryers wherein each one can be heated to a selected temperature for a selected residence time to provide an effective means to kill any seeds and sterilize the muck product. One to three dryers may be used, preferably at least two depending upon the feed rate and size of the dryer. It takes less time to heat and prepare a product for baling having straw lengths up to 10 inches than a hydro-mulch product having straw lengths averaging about ½ inch or less. The drying process includes drying of the material for a selected residence time of from 200 to 300° F. for three to five minutes in the tower dryer conveyed through a series of shelves while the material is subjected to a fabrication and expansion process utilizing fluffing cylinders 25 for enhanced drying, fragmenting, and pulping which expands, splits and creates more fibrous particles of straw increasing the surface area for adsorption of moisture in the subsequent hydro seeding process and absorption of moisture as a ground treatment component.

A feed control air lock system includes a HE-60 pull fan 26 providing a source of moving hot air and material through system. Material travels through the dryer at a selected rate and volume for further drying prior to being fed to a second cyclone 30 for removal of excess moisture and spent air prior to feeding the material into a hammer mill 32.

The material is ground in the hammer mill 32 at approximately 200° F. to a selected size, preferably ½ inch or less. The hammer mills include hammer, screens, and breaker bars or hardened material to resist wear and the abrasiveness of the material. A screen size of ⅝ inch is required to provide a product with ½ inch of size and vertically fracture the straw producing fibrous material to increase the surface area of the particles, increase absorption of moisture and expansion of the particles for application as a hydro mulch material when mixed with water and optionally a chemical fertilizer and/or optionally seed. The air handling fans are special wear fans designed to have a high rpm in order to facilitate the sizing process. The horse muck and wheat straw feed stream is dried below 10% moisture at this stage and cooled to 100° F. or less. Material is vertically fractured from the milling process for optimum performance for its intended use. At this point material, the material is environmentally friendly with a very low moisture and having a physical structure of the cellulose fibers sized and exposed for optimum performance in its intended use.

The processed muck material cooled to ambient temperature and deposited into a live floor surge bin 34 for bulk storage and transfer to the mixing station 36. The floor surge bin is designed to deposit material as needed for mixing.

The mixing station 38 includes at least one and preferably a plurality of mixers such as reel mixers. The stationary mixers 40 are reel or ribbon mixers which include special wipers for better lifting and mixing capabilities. The mixing station includes counter rotating augers in the bottom to continue the blending of said materials while distributing them to the compression bagger or other packaging station. The mixers mix a volume of 300 cubic feet per mixer of the fibrous materials.

Mixers break up and evenly distribute multiple additives with the horse muck with straw for a consistent engineered hydro mulch with organic fertilizer material. As material is deposited into mixer other ingredients of fibrous organic nature can be blended together for particular applications and transferred to a surge bin 42. The ingredients are mixed according to weight and bulk density. The dust prevention is controlled in order to mix the ingredient without lost of specific ingredients to maintain the integrity of the mix formula.

The base horse muck composition containing processed straw, urine, and manure is transferred to containers of a desired volume or weight. For instance, the product may be distributed to a compression bagger station 44 at approximately 7.5 cubic foot of volume where the product is compressed to 2.3 cubic feet of volume and bagged in 50 pound bags ready for transport. The containers are preferably moisture proof and air tight. Moisture and mix variations are adjusted to achieve said weight for specific blends of finished products.

In some applications, the material can be filled in bags, for instance in paper bags, which are then closed or sealed by means of a paper bag sewing machine. Paper bags are pervious to air and environmentally friendly. Material filled in paper bags does not go moldy and preserves the micro-organisms due to the air permeability of the paper bags. Both granulated and not granulated material can be dried and mixed in the above-mentioned drying and mixing process.

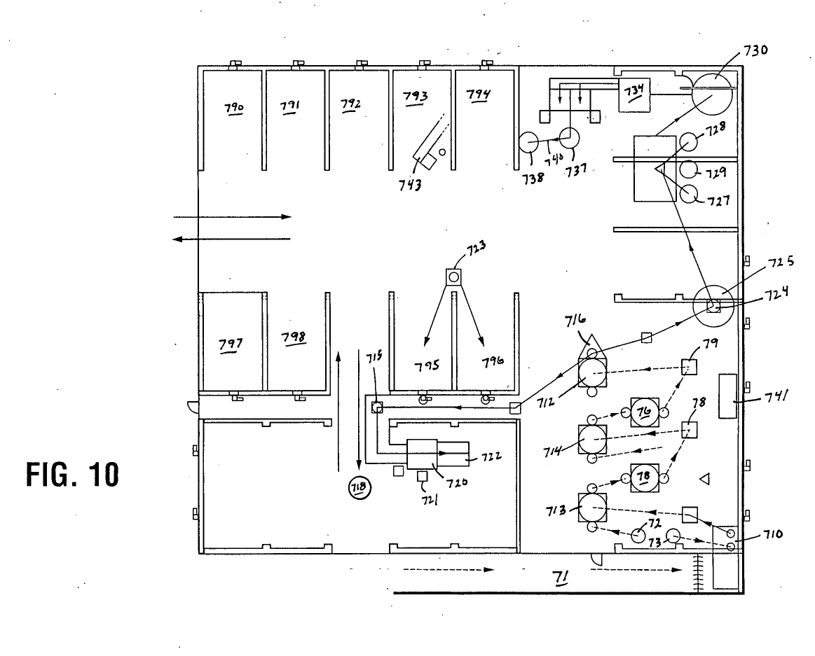

FIG. 10 shows a schematic of the process flow and equipment for one preferred embodiment of the present invention including the following components: 70 hotbox, 71 module feeder, 72 burner 1, 73 burner 2, 74 burner 3, 75 dryer 1, 76 dryer 2, 77 fan 1, 78 fan 2, 79 fan 3, 710 cyclone 1, 711 cyclone 2, 712 cyclone 3, 713 feed 1, 714 feed 2, 715 splitter transition, 716 hammer mill, 717cyclone re-bale, 718 surge bin long, 719 square baler, 720 bale bander, 721 power units, 722 conveyors, 723 screens, 724 cyclone for short straw, 725 surge bin for short straw, 726 unloader bin, 727 product bin 1, 728 product bin 2, 729 product bin 3, 730 finished product surge bin, 731 unloader for product surge, 732 air compressor, 733 reel mixer, 734 bully bagger feed, 735 bully bagger 1, 736 bully bagger 2, 737 palletizing frame, 738 pallet wrap, 739 convener, 740 conveyors, 741 dust and odor control, 742 moisture controls, 743 bale buster conveyor, 744 mobile equipment, 791 bin 1 compost, 792 bin 2 peat moss, 793 bin 3 wood, 794 bin 4 paper, 795 bin 5 cotton, 796 bin, and 797 bin.

FIG. 11 is a schematic showing an alternate embodiment process flow diagram including the following major components: 310 module feeder, 311 conveyor, 312 heater, 314 hot air fan, 316 rotary air lock to control feed rate, 318 blower, 319 variable speed rotary air lock, 320 cyclone, 322 hammer mill, 324 hot air shelf dryer, 326 blower, 328 cyclone, 330 hammer mill, 332 hot air shelf dryer, 334 blower, 336 cyclone, and 338 bagger. The module feeder holds the muck and provides it to the conveyor belt. A fan pulls hot air form the hot box which is mixed with the muck and blown through an air lock which controls the feed rate to the blower which blows the material to a cyclone or cyclone/hammer mill unit to reduce the size of the straw fragments. The material is then blown to a vertical shelf dryer for a selected residence time in the dryer at a selected temperature. The material is sucked into a blower and transferred to a second cyclone and/or cyclone/hammer mill then conveyed to a second shelf dryer for a selected residence time at a selected temperature. A fan conveys the dried material to a third cyclone whereby the material is conveyed to a packaging station for bulk container storage or bagging.

### Composition:

The base composition of the horse muck of the present includes wheat straw, manure and urine; however, it is contemplated that the horse could also contain some hay, sawdust or other contaminants in small amounts. The straw is typically from grain crops, such as barley, oats, or wheat. Any hay straw or wood chips in the muck would be considered a contaminant rendering the composition less effective.

The wheat straw typically contains 13% nitrogen, 3.3% phosphorous, and 23% potassium. The horse muck typically contains 14.9% nitrogen, 45% phosphorus, and 13.2% potassium. One ton of straw horse muck contains: 1600 pounds of H2O, 10 pounds of nitrogen, 5 pounds of phosphorus, 101 lbs of potassium. Horse urine contains 3 pounds of nitrogen, and 3 pounds of potassium. According to an assay sample from Ohio State University, the horse muck sample contained 70.8% water, 0.51% nitrogen, 0.21% phosphorus, and 0.68 to 0.90% potassium. A 1000 pound horse makes 50 pounds of manure a day and 10 pounds of urine a day which equates to 20 pounds of soiled bedding (muck) a day. The density of the wheat straw is 2.5 pounds per cubic foot which has a capacity to absorb 2.2 pounds per 20 pounds of straw.

Usually about 100-150 pounds of straw is used to absorb about 60 pounds of animal waste a day. Thus, the content of the waste products in the straw will vary, but typically muck will contain from 10 to 20 percent waste products “manure” and 80 to 90 percent straw. Upon drying the product typically contains about 99% straw but depending upon the application, the muck product may contain 1 to 5% dried waste material and 95 to 99% straw.

Treatment of the horse muck according to the process described herein pulverizes and fragments the straw increasing the surface area and adsorption area of the straw particles allowing longer straw particles up to ½ inch long to be used which forms a bridge between the straw and paper particles upon deposition on the ground surface to be treated as compared to the conventional hydro mulch using straw particles of a smaller size of about ¼ inch because the straw is processed with using conventional equipment which mixes but does not fragment or pulp the straw segments.

Pre-ground additives of shredded or pulped paper, and/or wood shavings, and/or cotton may optionally be added to the horse muck composition, but is not necessary.

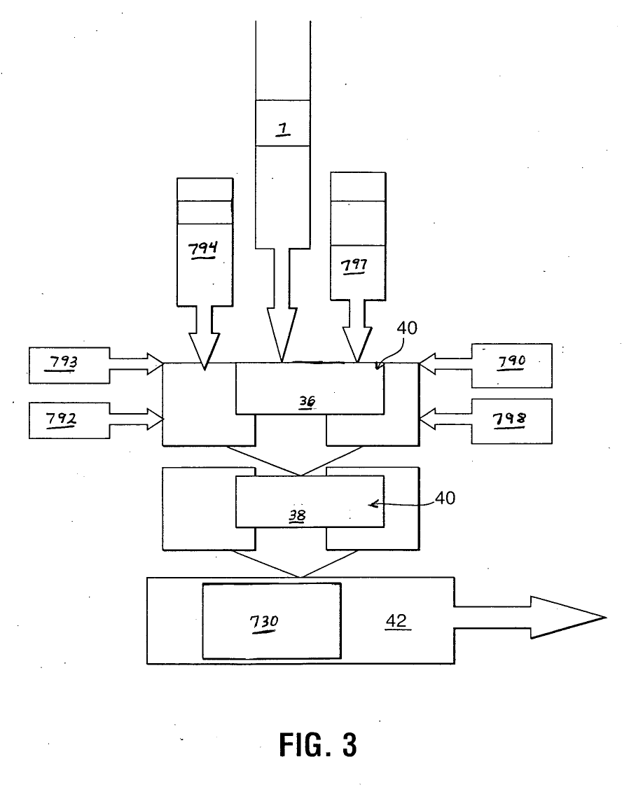

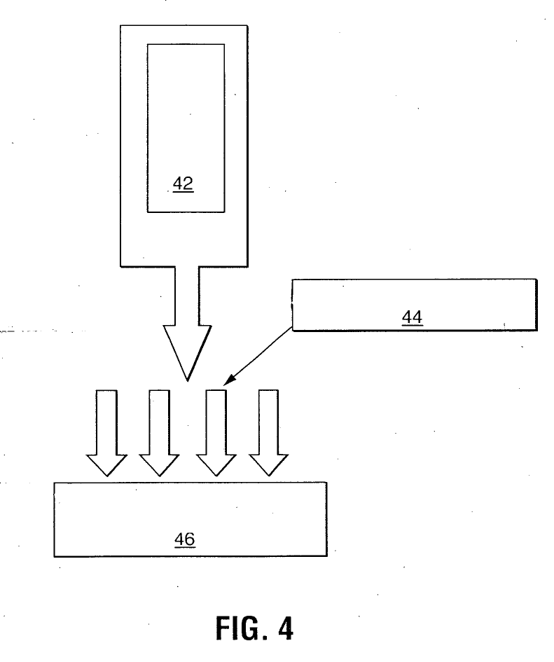

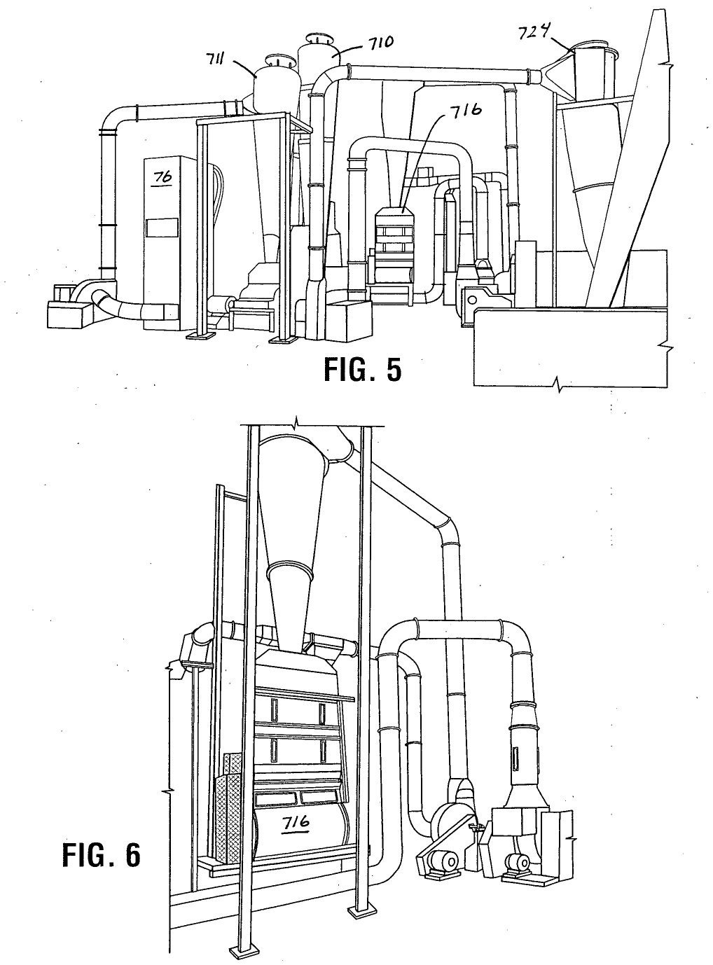

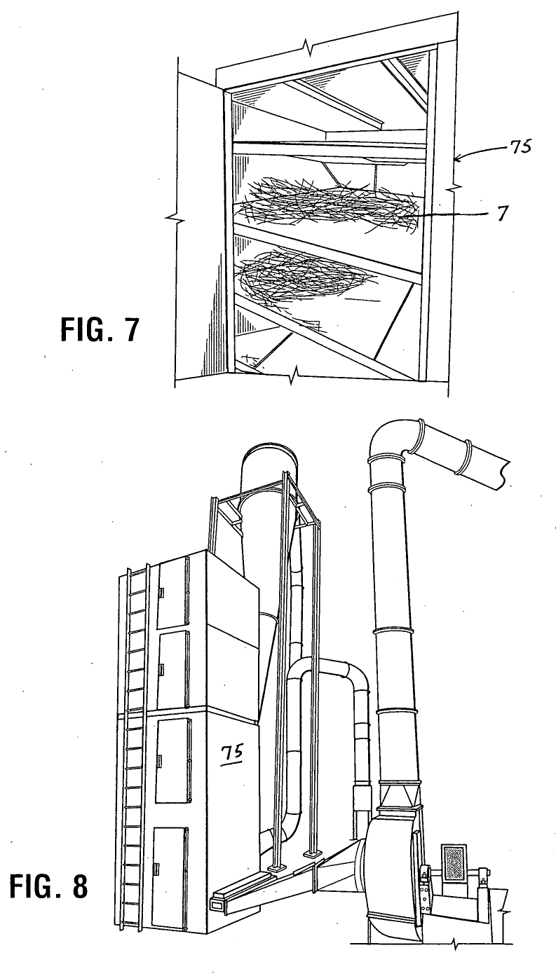

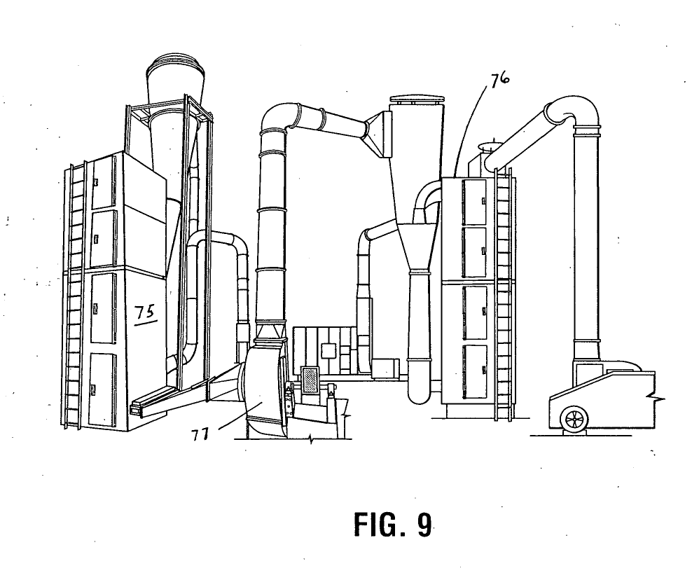

Paper can be added to the processed horse muck in the mixing stage as shown in FIG. 3 in an effective amount to retain water in the composition to form a slurry for spreading the hydro-mulch composition by pumping the composition onto the surface to be treated. The paper is usually ground into small particles of less than ½ inch and preferably even smaller and mixed with the horse muck composition. The paper holds the water to hold the horse muck straw mixture into a slurry solution better than a horse muck solution using straw alone because the water does not remain in solution with the straw to form as stable a solution for pumping as when the mixture contains from 0 up to 30% by weight paper, and typically from 20-30% paper.

Wood fibers or shavings which have been subjected to defragmentation to pulverize the wood forming expanded fibrous fragments may also be added to the horse muck composition in an amount of from 0 up to 30% by weight and preferably from 10-20% instead of or in addition to the paper. The material once processed by physical reduction and/or steam resembles fuzz or a stringy material.

Cotton may also be used together with wood or paper or instead of same in an amount up to 30% by weight, but less than 10% and more preferably at about 5% in combination with the horse muck and or paper.

A Tackifiers such as a guar and/or polyacrylic compound may be used to hold the particles together upon application to the ground to prevent washing. The tackifier is usually an organic tackifier such as guar, or starch based tackifier or other water soluble polymers. The tackifier acts as a glue to hold the material together. The amount used is dependent upon the slope of the ground to be covered and may vary from 0 up to 10% by weight and more preferably from 2.5 to 7.5%, and most preferably from 5 to 7 percent.

Surfactant up to 1% by weight may also be used to enhance wettability of the paper.

One preferred embodiment contains 100% processed muck and more preferably from 25 to 85 percent processed muck, and more preferably from 50 to 75% processed muck; up yo 30 percent paper; and from about 0.5 to 10% tackifiers.

A selected amount of seed, alfalfa meal or peat compost may be added to the horse muck composition or base composition with other selected ingredients to provide a soil replacement composition for treatment of ground which lacks a soil component to grow plants such as clay.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplification presented herein above. Rather, what is intended to be covered is within the spirit and scope of the appended claims.

We claim:

1. A hydro-mulch and fertilizer composition, comprising:
an effective amount of wheat straw;
an effective amount of animal manure;
an effective amount of animal urine;
a Tackifiers;
an effective amount of water to form a pumpable slurry.
